(19) United States
(12) Patent Application Publication
(10) Pub. No.: US 2021/0035305 A1
(43) Pub. Date: Feb. 4, 2021

(54) IMAGE-BASED CLASSIFICATION SYSTEM

(71) Applicant: UTECHZONE CO., LTD., New Taipei City (TW)

(72) Inventors: CHIH-HENG FANG, New Taipei City (TW); CHIA-LIANG LU, New Taipei City (TW); CHIA-TE LIAO, New Taipei City (TW)

(21) Appl. No.: 16/934,728

(22) Filed: Jul. 21, 2020

(30) Foreign Application Priority Data
Jul. 31, 2019 (TW) 108127221

(51) Int. Cl. G06T 7/11; G06K 9/32; G06N 3/04; G06T 11/20

(52) U.S. Cl. CPC G06T 7/11; G06K 9/3233; G06T 2210/12; G06T 11/20; G06N 3/04

(57) ABSTRACT

The present disclosure provides an image-based classification system, comprising an image capturing device, and a processing device connected to the image capturing device. The image capturing device is used for capturing an image of an object. The object has a surface layer and an inner layer. The processing device is configured to use a deep learning model, perform image segmentation on the image of the object, define a surface-layer region and an inner-layer region of the image, and generate classification information. The surface-layer region and the inner-layer region correspond respectively to the surface layer and the inner layer of the object.

### BACKGROUND OF THE DISCLOSURE

### 1. Technical Field

The present disclosure relates to an image-based classification system. More particularly, the disclosure relates to an image classification system that uses an artificial neural network to perform image segmentation on an image of an object in order to inspect any irregularity in an inner layer of the object.

### 2. Description of Related Art

Automated optical inspection equipment has wide application and is frequently used in the front-end and back-end manufacturing processes of display panels and semiconductor products to inspect product defects. For example, an automated optical inspection system associated with the manufacture of display panels may carry out glass inspection, array inspection (in the front-end array manufacturing process), color filter inspection, and back-end liquid crystal module inspection, etc.

While classifying the image materials through machine vision, a conventional automated optical inspection system typically uses an edge detection algorithm to determine edge locations, and in some cases the image being analyzed must be manually marked to create proper masks (e.g., when a watershed algorithm is used). Such image classification methods have decent reliability but are disadvantaged by their operational limitations and unsatisfactory inspection efficiency.

### BRIEF SUMMARY OF THE DISCLOSURE

The primary objective of the present disclosure is to provide an image-based classification system, comprising an image capturing device, and a processing device connected to the image capturing device. The image capturing device is used for capturing an image of an object, wherein the object has a surface layer and an inner layer. The processing device is configured to use a deep learning model, perform image segmentation based on the image of the object, define a surface-layer region and an inner-layer region of the image, and generate classification information. The surface-layer region and the inner-layer region correspond respectively to the surface layer and the inner layer of the object.

The present disclosure is so designed that, without having to resort to manually designed features, an artificial neural network can automatically extract the region corresponding to an irregularity in an inner layer of a display panel from an image of the display panel so as to improve the efficiency and the reliability of the inspection.

According to the present disclosure, image segmentation for, and defect inspection from, an image in a region corresponding to an irregularity in an inner layer of the object can be completed in one inspecting procedure, thus providing better inspection efficiency than that of the conventional algorithms.

### BRIEF DESCRIPTION OF THE SEVERAL VIEWS OF THE DRAWINGS

FIG. 1 is a schematic drawing of an image-based classification system according to an embodiment of the present disclosure.

FIG. 2 is a block diagram of the image-based classification system according to the embodiment of the present disclosure.

FIG. 3 is a structural diagram of an artificial neural network of the present disclosure.

FIG. 4 is a structural diagram of a backbone network of the present disclosure.

FIG. 5 is a structural diagram of a region proposal network of the present disclosure.

FIG. 6 is a process flow of a proposal layer of the present disclosure.

FIG. 7 is a schematic drawing of a pooling operation of a ROI (region of interest) aligning module of the present disclosure.

FIG. 8 is a structural diagram of a fully convolutional network of the present disclosure.

### DETAILED DESCRIPTION OF THE DISCLOSURE

The details and technical solution of the present disclosure are hereunder described with reference to accompanying drawings. For illustrative sake, the accompanying drawings are not drawn to scale. The accompanying drawings and the scale thereof are not restrictive of the present disclosure.

The present disclosure is intended for use in an automated optical inspection (AOI) system and involves automatically generating a mask in an image of a display panel through an artificial neural network and extracting a region of interest (i.e., a region on which defect inspection will be performed) from the image according to the mask, in order to achieve higher inspection reliability and higher inspection efficiency than in the prior art.

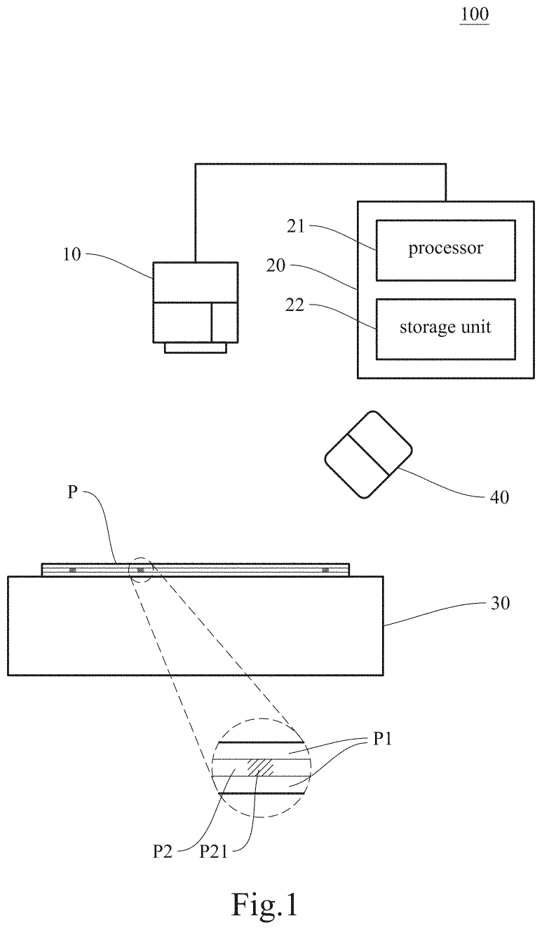

Please refer to FIG. 1 for a schematic drawing of an image-based classification system according to an embodiment of the present disclosure.

In this embodiment, the image-based classification system 100 essentially includes an image capturing device 10 (e.g., a camera), and a processing device 20 connected to the image capturing device 10. To enable fully automated inspection and fully automated control, a carrier 30 is generally also included to carry an object P to an inspection area, where images of the object P are taken. In addition, for different types of the object P or defects, the image-based classification system 100 may be mounted with a variety of auxiliary light sources 40 for illuminating the object P. The auxiliary light source 40 may be, but is not limited to, a lamp for emitting collimated light, a lamp for emitting diffused light, or a dome lamp. Depending on the type of the object P, two or more auxiliary light sources 40 may be required at the same time for some special objects P.

The camera for use in an automated optical inspection should be chosen according to the practical requirements. A high-precision camera is called for when stringent requirements are imposed on the precision and the reliability of a workpiece to be inspected. A low-end camera, on the other hand, may be used to reduce equipment cost. In short, the choice of the camera is at the user's discretion. Cameras for automated optical inspection can be generally categorized as area scan cameras or line scan cameras, either of which may be used to meet the practical requirements. A line scan camera is often used for dynamic inspection, in which the object P is photographed while moving, and which ensures the continuity of inspection process.

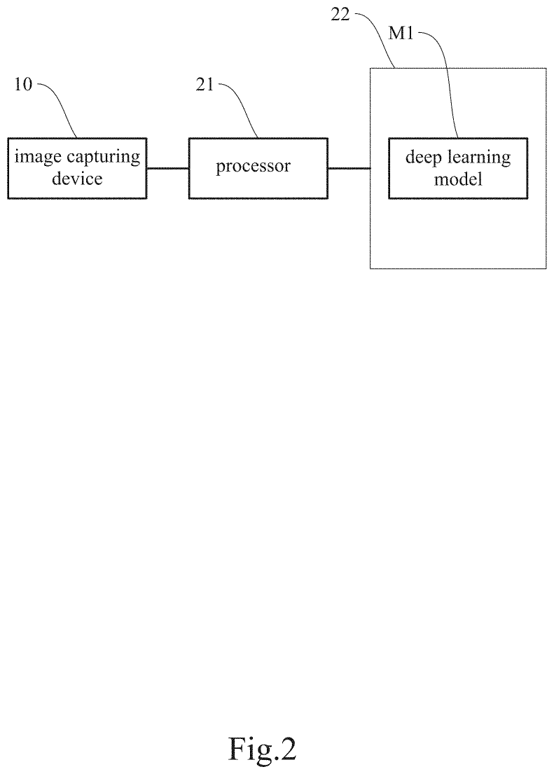

The image capturing device 10 is connected to the back-end processing device 20. Images taken by the image capturing device 10 are analyzed by the processor 21 of the processing device 20 in order to find defects on the surface of, or inside, the object P. Preferably, the image capturing device 10 is provided with a microprocessor (generally a built-in feature of the image capturing device 10) for controlling the image capturing device 10 or preprocessing the images taken by the image capturing device 10. After the processor 21 of the processing device 20 obtains images from the image capturing device 10 (or its microprocessor), the processor 21 preprocesses the images (e.g., through image enhancement, noise removal, contrast enhancement, edge enhancement, feature extraction, image compression, and/or image conversion), and outputs the preprocessed images to be analyzed by a visual software tool and related algorithms so as to produce a determination result, which is either output or stored in a database. In this embodiment, the processor 21 is configured to load a deep learning model M1 (see FIG. 2) from a storage unit 22 in order to perform the automated optical inspection.

Please refer to FIG. 2 for a block diagram of the image-based classification system according to the embodiment of the present disclosure.

The present disclosure uses a mask region-based convolutional neural network (or Mask RCNN for short) as its major structure and modifies the network in order to achieve image segmentation and defect identification (inspection) at the same time. Image segmentation and defect inspection are performed by the processor 21 after the processor 21 loads the data in the storage unit 22. The collaboration between the processor 21 and the storage unit 22, however, is not an essential feature of the disclosure and therefore will not be detailed herein.

The processor 21 is configured to execute the deep learning model M1 after loading from the storage unit 22, to define a surface-layer region P1 and an inner-layer region P2 of an image of the object P and thereby generate the corresponding classification information, to identify any defect P21 in the inner-layer region P2 according to the classification information, and to produce an inspection result.

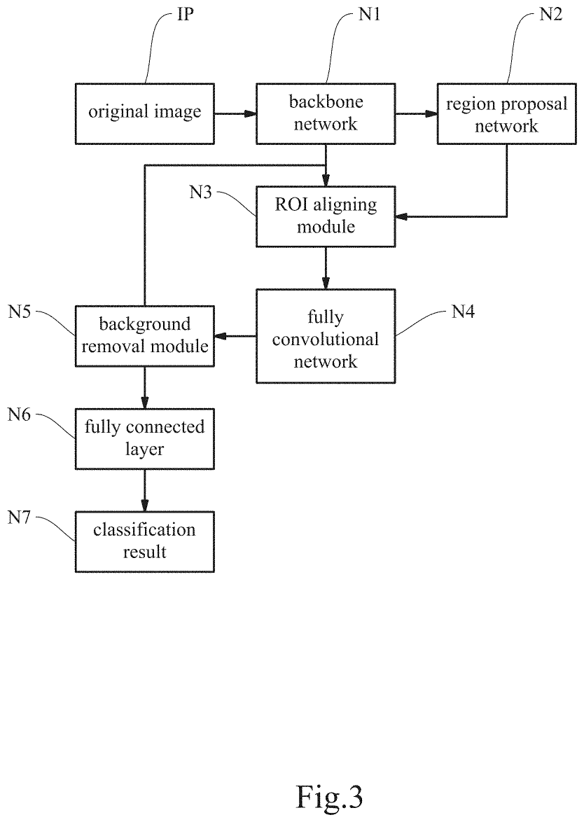

A preferred embodiment of the present disclosure is described below with reference to FIG. 3 to FIG. 8, which show structural diagrams of an artificial neural network, a backbone network, and a region proposal network used in the disclosure; a process flow of a proposal layer; a schematic drawing of a pooling operation of an ROI (region of interest) aligning module; and a structural diagram of a fully convolutional network.

Referring to FIG. 3, the deep learning model M1 essentially includes a backbone network N1, a region proposal network (RPN) N2, an ROI aligning module N3, a fully convolutional network (FCN) N4, a background removal module N5, and a fully connected layer N6. Once the image of the object P is input into the deep learning model M1, the deep learning model M1 generates the corresponding classification information and marks the surface-layer region P1 and the inner-layer region P2 accordingly for distinction. Any defect P21 in the inner-layer region P2 will then be identified, and the inspection result is thus produced.

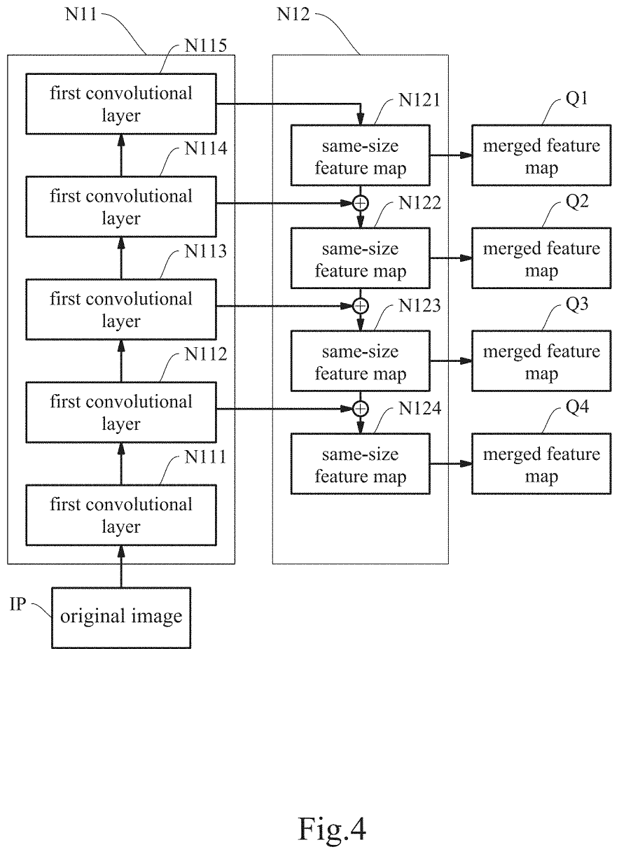

Referring to FIG. 4, the backbone network N1 serves mainly to perform feature extraction on an original image IP of the object P (e.g., a display panel), with a view to obtaining at least one feature map. In this embodiment, the backbone network N1 includes a feature extraction network N11 and a feature pyramid network (FPN) N12.

The feature extraction network N11 includes a plurality of first convolutional layers N111, N112, N113, N114, and N115, which are sequentially arranged in a bottom-to-top order, with the bottom convolutional layer (e.g., the first convolutional layer N111) configured to extract the low-level features in the image being analyzed, and the upper convolutional layers (e.g., the first convolutional layers N112 to N115) configured to extract the high-level features in the image being analyzed. The number of the convolutional layers can be set as required by the samples and is not an essential feature of the present disclosure. The original image IP is normalized before being input into the bottom first convolutional layer N111 and has its features extracted in the first convolutional layers N111 to N115 to produce a plurality of feature maps. In one preferred embodiment, the feature extraction network N11 is a deep residual network (ResNet), whose relatively good convergence properties solve the degradation problem of a deep network.

As far as target inspection is concerned, a relatively low-level feature map contains a relatively small amount of information but is relatively large in size and hence relatively accurate in terms of target position, which helps identify image details. A relatively high-level feature map, on the other hand, contains a relatively large amount of information but is relatively inaccurate in terms of target position, with relatively large strides that hinder the inspection of relatively small targets in the image being analyzed. To enhance the accuracy of inspection, the backbone network N1 further includes the feature pyramid network N12 to ensure the accuracy of target positions as well as the desired amount of information. More specifically, the feature pyramid network N12 upsamples pixels in the feature maps output from the upper first convolutional layers N112, N113, N114, and N115 to obtain a plurality of same-size feature maps N121, N122, N123, and N124, which correspond in number to the outputs of the feature extraction network N11 and also correspond in size respectively to the feature maps output from the first convolutional layers N112, N113, N114, and N115. The feature pyramid network N12 then merges each of the feature maps output from the first convolutional layers N112, N113, N114, and N115 with the corresponding same-size feature maps N121, N122, N123, or N124 to obtain a plurality of initially merged feature maps, on which convolution is subsequently performed by the plural second convolutional layers of the feature pyramid network N12 respectively to produce a plurality of merged feature maps Q1, Q2, Q3, and Q4 to be output by the feature pyramid network N12. Therefore, the bottom-layer output can be used to inspect small targets in the image being analyzed; the middle-layer outputs, to inspect medium-sized targets; and the top-layer output, to inspect large targets. The selected output features are dynamically determined according to target size.

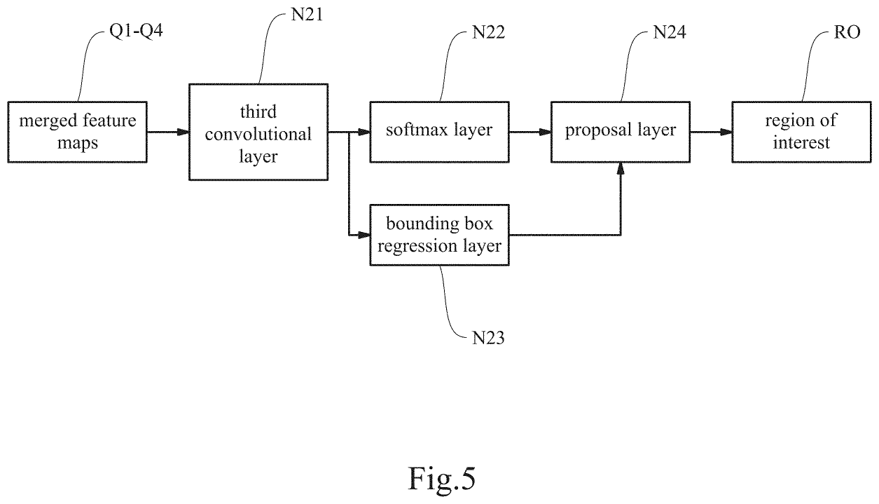

Referring to FIG. 5, the region proposal network N2 is connected to the backbone network N1 and is configured to obtain the feature maps from the backbone network N1 and determine at least one region of interest according to the feature maps. The region proposal network N2 is a small neural network that scans an image through a sliding window in order to find the region(s) where the target is present. More specifically, the region proposal network N2 includes a third convolutional layer N21, a softmax layer N22, a bounding box regression layer N23 and a proposal layer N24. The third convolutional layer N21 performs convolution on the merged feature maps Q1-Q4 according to preset anchor boxes and thereby obtains a plurality of proposal bounding boxes for output. The softmax layer N22 classifies each proposal bounding box as foreground or background based on the probability (or score) of the proposal bounding box containing an object and outputs the classification results. The bounding box regression layer N23 outputs the transformation values of each proposal bounding box to the proposal layer N24. The proposal layer N24 determines at least one region of interest RO by fine-tuning the proposal bounding boxes according to the transformation values as well as those proposal bounding boxes classified as foreground. It is worth mentioning that the anchor boxes may vary in size and aspect ratio, and that the number of the anchor boxes is not an essential feature of the present disclosure.

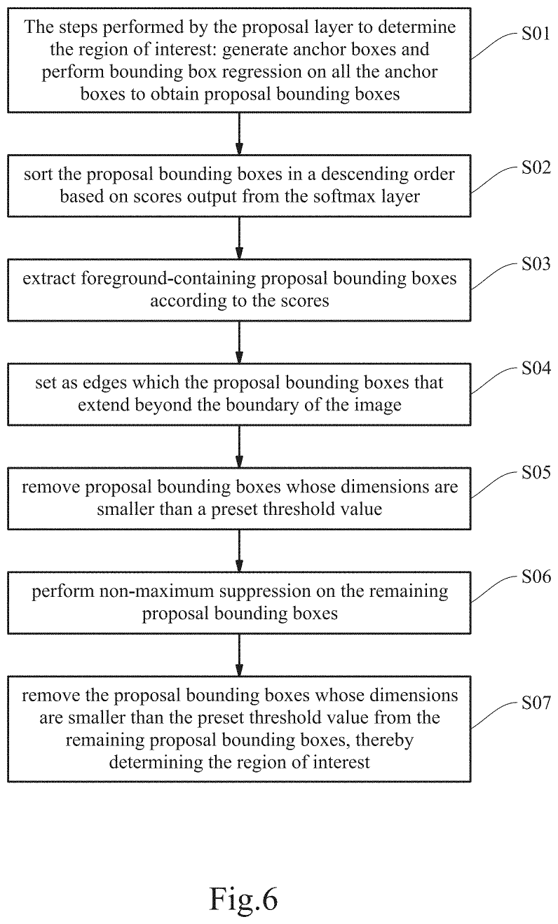

More specifically, referring to FIG. 6, the proposal layer N24 performs the following steps to determine the at least one region of interest RO. Step S01: generating the anchor boxes and performing bounding box regression on all the anchor boxes to obtain the proposal bounding boxes. Step S02: sorting the proposal bounding boxes in a descending order based on the scores output from the softmax layer N22. Step S03: extracting the foreground-containing proposal bounding boxes according to the scores. Step S04: setting as edges which the proposal bounding boxes that extend beyond the boundary of the image. Step S05: removing the proposal bounding boxes whose dimensions are smaller than a preset threshold value. Step S06: performing non-maximum suppression (NMS) on the remaining proposal bounding boxes. Step S07: removing the proposal bounding boxes whose dimensions are smaller than the preset threshold value from the remaining proposal bounding boxes, thereby determining the at least one region of interest RO.

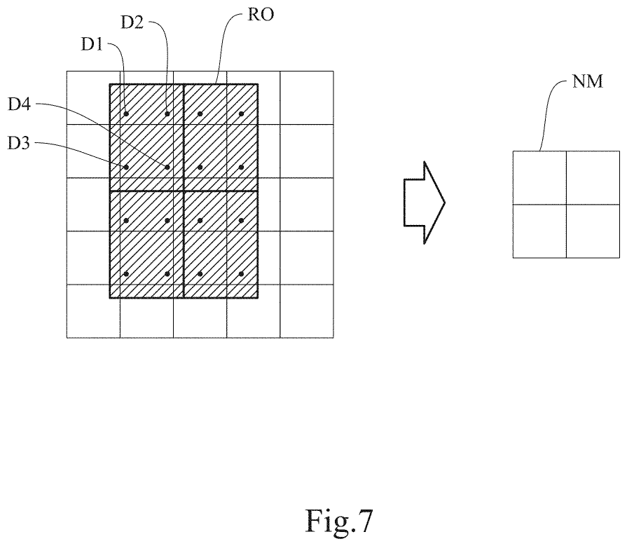

Generally, a classifier is designed to deal with fixed input dimensions only and cannot deal with variable input dimensions properly. Now that the bounding box fine-tuning step of the region proposal network N2 allows the at least one region of interest RO to have different sizes, image compression must be carried out by a pooling operation in order to normalize the input image. During the pooling operation, the ROI aligning module N3 uses bilinear interpolation to reduce errors resulting from quantification, or more particularly from the rounding of floating-point numbers. More specifically, referring to FIG. 7, the major steps performed by the ROI aligning module N3 are as follows: traversing each of the at least one region of interest RO and maintaining the floating-point-number boundaries (i.e., without quantification); dividing each of the at least one region of interest RO into k×k units (e.g., 2×2 units as shown in FIG. 7); using bilinear interpolation to calculate the coordinates of the four fixed positions D1, D2, D3, and D4 in each unit; and performing max pooling to obtain a normalized image NM.

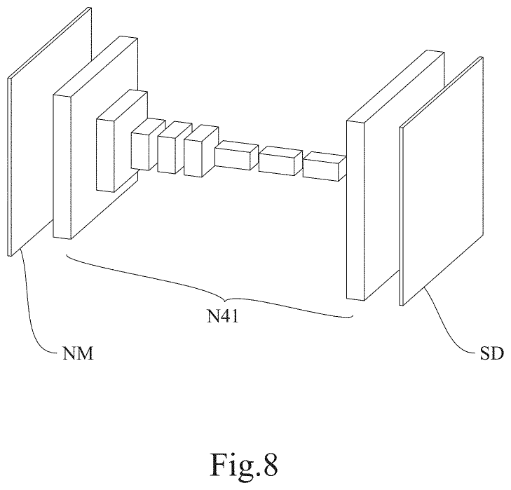

Once the normalized image NM is input into the fully convolutional network N4, referring to FIG. 8, the plural fourth convolutional layers N41 in the fully convolutional network N4 perform their respective computation on the normalized image NM to obtain a segmentation mask. To avoid repeated computation, the segmentation mask is subjected to error compensation and is then mapped onto the corresponding feature map to produce an instance segmentation mask SD, which is output by the fully convolutional network N4. Error compensation is performed because downsampling has been repeated in the front-end portion of the convolutional neural network, making the mask output from the fully convolutional network N4 a relatively coarse, or low-resolution, one. To produce a better instance segmentation mask SD, upsampling is conducted to make up for the missing pixels, and the results of first few layers are used for error compensation. The resulting instance segmentation mask SD, therefore, is derived from the mask features and the mask loss function of the fully convolutional network N4.

Through the foregoing computations, the deep learning model M1 produces a total of three outputs, namely the merged feature maps Q1-Q4, the at least one region of interest RO and the instance segmentation masks SD, wherein the instance segmentation masks SD have been directly mapped onto the merged feature maps Q1-Q4 to avoid repeated feature extraction.

Thus, the processing device 20 performs inspection according to the aforesaid classification information, identifies any defect in the inner-layer region P2, and outputs the inspection result.

As stated above, the deep learning model M1 further includes the background removal module N5 and the fully connected layer N6. The background removal module N5 associates the merged feature maps Q1-Q4 with the at least one region of interest RO, segments the merged feature maps Q1-Q4 accordingly, and removes the background of the segmented merged feature maps Q1-Q4 according to the instance segmentation masks SD to obtain background-removed feature images of the object P. As the input of the fully connected layer N6 must be a normalized image, the background-removed areas of the background-removed feature images can be filled with a single image parameter in order for the images input into the fully connected layer N6 to meet the aforesaid requirement. (It is worth mentioning that training images used in the training process may be images with both the inner-layer region and the surface-layer region or images with only the inner-layer region.) Once the background-removed feature images of the object P are input into the trained fully connected layer N6, whose output end may be the softmax layer N22, the trained fully connected layer N6 weights and classifies the images and then outputs a classification result N7, such as “non-defective” or the type(s) of the defect(s).

According to the above, the present disclosure is so designed that an artificial neural network can automatically extract from an image of a display panel the region corresponding to an irregularity in an inner layer of the display panel. In addition, according to the present disclosure, image segmentation for, and defect inspection from, an image with the region corresponding to the irregularity in the inner layer of the object can be completed in one inspection procedure, thus providing much higher inspection efficiency than achievable by the conventional algorithms.

The above is the detailed description of the present disclosure. However, the above is merely the preferred embodiment of the present disclosure and cannot be the limitation to the implement scope of the present disclosure, which means the variation and modification according to the present disclosure may still fall into the scope of the disclosure.

What is claimed is:

1. An image-based classification system, comprising:
an image capturing device, adapted for capturing an image of an object, wherein the object has a surface layer and an inner layer; and
a processing device, connected to the image capturing device and configured to use a deep learning model, perform image segmentation on the image of the object, define a surface-layer region and an inner-layer region of the image, and generate classification information, wherein the surface-layer region and the inner-layer region correspond respectively to the surface layer and the inner layer of the object.

2. The image-based classification system of claim 1, wherein the processing device is configured to use the deep learning model, performs inspection according to the classification information, identifies any defect in the inner-layer region, and outputs an inspection result.

3. The image-based classification system of claim 2, wherein the deep learning model comprises:
a backbone network, adapted for performing feature extraction on an original image of the object and thereby obtaining at least one feature map;
a region proposal network (RPN), connected to the backbone network and configured to obtain the feature map from the backbone network and determine at least one region of interest according to the feature map;
a region-of-interest (ROI) aligning module, adapted for performing a bilinear interpolation-based pooling operation on an image area corresponding to a region of interest and thereby obtaining a normalized image;
a fully convolutional network, including a plurality of convolutional layers, wherein after the normalized image is input into the fully convolutional network, the convolutional layers perform computation on the normalized image to obtain a segmentation mask, and the fully convolutional network obtains an error-compensated segmentation mask by performing error compensation on the segmentation mask, obtains an instance segmentation mask by mapping the error-compensated segmentation mask onto the feature map, and outputs the instance segmentation mask;
a background removal module, adapted for removing a background of the image area corresponding to the region of interest according to the instance segmentation mask and thereby obtaining a background-removed feature image of the object; and
a fully connected layer, wherein after the background-removed feature image of the object is input into the fully connected layer, the fully connected layer classifies the background-removed feature image of the object and outputs a classification result.

4. The image-based classification system of claim 3, wherein the backbone network comprises:
a feature extraction network, including a plurality of first convolutional layers sequentially arranged in a bottom-to-top order, wherein the original image is input into the bottom one of the first convolutional layers after being normalized, in order for the first convolutional layers to perform feature extraction on the normalized original image and thereby obtain a plurality of feature maps; and
a feature pyramid network (FPN), including a plurality of second convolutional layers, wherein the feature pyramid network upsamples the feature maps output from the upper first convolutional layers to obtain a plurality of same-size feature maps corresponding in size respectively to the feature maps output from the first convolutional layers, the feature pyramid network merges each of the feature maps output from the first convolutional layers with a corresponding one of the same-size feature maps to obtain a plurality of initially merged feature maps, the second convolutional layers perform convolution on the initially merged feature maps respectively to obtain a plurality of merged feature maps, and the feature pyramid network outputs the merged feature maps.

5. The image-based classification system of claim 4, wherein the feature extraction network is a deep residual network (ResNet).

6. The image-based classification system of claim 5, wherein the region proposal network includes a third convolutional layer, a softmax layer, a bounding box regression layer and a proposal layer; the third convolutional layer performs convolution on the merged feature maps according to preset anchor boxes to obtain a plurality of proposal bounding boxes for output; the softmax layer classifies each proposal bounding box as foreground or background, and outputs foreground/background classification results; the bounding box regression layer outputs transformation values of the proposal bounding boxes to the proposal layer; and the proposal layer determines the at least one region of interest by fine-tuning the proposal bounding boxes according to the transformation values as well as the proposal bounding boxes classified as foreground.

7. The image-based classification system of claim 6, wherein the proposal layer performs the following steps to determine the at least one region of interest:
generating the anchor boxes;
performing bounding box regression on all the anchor boxes to obtain the proposal bounding boxes;
sorting the proposal bounding boxes in a descending order based on the scores output from the softmax layer;
extracting the foreground-containing proposal bounding boxes according to the scores;
setting as edges which the proposal bounding boxes that extend beyond the boundary of the image;
removing all the proposal bounding boxes whose dimensions are smaller than a preset threshold value;
performing non-maximum suppression (NMS) on the remaining proposal bounding boxes; and
removing the proposal bounding boxes whose dimensions are smaller than the preset threshold value from the remaining proposal bounding boxes, thereby determining the at least one region of interest.

8. The image-based classification system of claim 1, adapted for use in inspecting an irregularity in the inner layer of the object.

9. The image-based classification system of claim 2, adapted for use in inspecting an irregularity in the inner layer of the object.

10. The image-based classification system of claim 3, adapted for use in inspecting an irregularity in the inner layer of the object.

11. The image-based classification system of claim 4, adapted for use in inspecting an irregularity in the inner layer of the object.

12. The image-based classification system of claim 5, adapted for use in inspecting an irregularity in the inner layer of the object.

13. The image-based classification system of claim 6, adapted for use in inspecting an irregularity in the inner layer of the object.

14. The image-based classification system of claim 7, adapted for use in inspecting an irregularity in the inner layer of the object.
